(19) United States
(12) Patent Application Publication
(10) Pub. No.: US 2010/0165377 A1
(43) Pub. Date: Jul. 1, 2010

(54) METHOD AND DEVICE FOR ARCHIVING PRINTED IMAGES

(76) Inventor: Michael Has, Erding (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/294,731

(22) PCT Filed: Mar. 27, 2007
(86) PCT No.: PCT/EP2007/052920

§ 371 Date: Sep. 26, 2008

(30) Foreign Application Priority Data
Mar. 27, 2006 (DE) 10 2006 014 043.5

(51) Int. Cl. G06F 15/00

(52) U.S. Cl. 358/1.15

(57) ABSTRACT

In a method or system to archive print images, at least one print image generated with aid of a printing or copying system is recorded with aid of a recording unit. Image data corresponding to the recorded print image are generated. The image data are archived in an archive. At least one part of print data used to generate the print image is stored together with the image data in the archive.

### BACKGROUND

The embodiment concerns a method and a device to archive print images in which corresponding image data in a print image are generated and archived.

Various archiving possibilities are known for archiving of print data. For example, print data streams with indexing information are provided and stored in an archive. For example, this is described in the previously unpublished patent application DE 10 2006 006 060 by the applicant, as well as in the document U.S. Pat. No. 5,940,584. Systems are also known for archiving of rastered print data that correspond to the print image output by a printer or copier. The print data of all printed, copied or faxed documents can thereby be archived, in particular with the aid of a document management system, as described in the document U.S. Pat. No. 5,978,477, for example.

Furthermore, automatic systems are known for checking print images of a printed document, which systems detect at least portions of a printed document and, using the print data used to generate these documents, checking whether the content of these documents or these detected portions have been correctly generated. In particular, printed barcodes as well as text are detected that have been printed with the aid of printing inks or printing materials that contain magnetizable particles. At least portions of a printed print image (for example address information) can also be detected with the aid of a digital camera. The correct output of this information can be checked with the aid of the print data used to generate the print image. Such systems are in particular known from the documents U.S. Pat. No. 6,137,967, U.S. Pat. No. 6,324,353 B1 and EP 1 085 451 A2. The cited documents are incorporated by reference into the present specification.

To regulate electrographic parameters, it is known from U.S. Pat. No. 6,136,967 (for example) to optoelectronically scan printed documents and to correct the parameters based on the scan result.

The correct reproduction of information in printed documents is checked by random sampling in the course of a quality management in organizations according to the ISO 9000 ff standard. However, it is thereby not provided to track which information was or is actually extractable from a sent document.

### SUMMARY

It is the object of the invention to specify a method and a device for archiving of print images via which a reliable statement about the printed content is possible, even after sending a document.

In a method or system to archive print images, at least one print image generated with aid of a printing or copying system is recorded with aid of a recording unit. Image data corresponding to the recorded print image are generated. The image data are archived in an archive. At least one part of print data used to generate the print image is stored together with the image data in the archive.

### BRIEF DESCRIPTION OF THE DRAWINGS

FIG. 1 is a system to record and archive print images printed on a medium material, according to a first embodiment of the invention;

FIG. 2 is a system to record and archive print images printed on a medium material, according to a second embodiment of the invention;

FIG. 3 is a system to record and archive print images printed on a medium material, according to a third embodiment of the invention;

FIG. 4 is a system to record and archive print images printed on a medium material, according to a fourth embodiment of the invention;

FIG. 5 is a system to record and archive print images printed on a medium material, according to a fifth embodiment of the invention; and

FIG. 6 is a system to record and archive print images printed on a medium material, according to a sixth embodiment of the invention.

### DESCRIPTION OF THE PREFERRED EMBODIMENTS

For the purposes of promoting an understanding of the principles of the invention, reference will now be made to the preferred embodiments/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

Via the method and the device according to at least one or more of the preferred embodiments it is achieved that when the actual printed print images are archived, whereby images of the printed documents can be output (in particular displayed) by selecting and processing the archived image data of the actual printed print image. Content visible in this document can therefore be determined and checked even at a later point in time, and comparison prints can be produced as necessary. For example, images of the actual printed print images of sent documents can thus be displayed. This is in particular possible given inquiries by the recipient to the sender regarding this document. If the archived information are provided to a call center, the recipient can also call the call center, wherein images of the documents sent to the recipient can then be displayed to the employee of the call center by calling up the corresponding archive data, whereby images of the actual printed and sent documents are available to the employee. The print data (i.e. a print data stream and/or rastered image data) used to generate the print image are also additionally archived, advantageously together with the recorded image data in the archive or alternatively, in an additional archive. It can thereby be checked, even at a later point in time, whether the actual printed print image coincides with the print data for generation of the print image, whereby causes of error given missing information or print errors can be localized in a simple manner.

Upon archiving, the image data to be archived are advantageously provided with indexing information via which the image data can be located simply even at an arbitrary later point in time. Such indexing information can be address information of a receiver, date information of the printing date, shipping date, barcode information or other suitable indexing information for indexing the image data, for example. The indexing information can additionally or alternatively also be determined with the aid of the print job chaperone data, with the aid of the print data for generation of the print image and/or information contained in a job ticket. A print image of a surface or multiple print images with a respective surface that corresponds to a standard paper format of a printed single sheet is advantageously recorded.

The single sheet or the single sheets can be cut from an endless medium material web in a post-processing, i.e. after the printing. The recording of the print images to be archived can occur before or after the cutting.

In particular given production of documents by printing of web-shaped medium material (advantageously of web-shaped paper webs), at least one or more of the preferred embodiments enables it to be ensured that the print data for generation of the print images of these documents have been supplied to the printer, and that no error message has been output upon generation of the document by the printer. Whether errors have occurred in the processing of the print data (in particular whether the correct addresses are present in provided address fields on letters to be printed) can thus be reliably traced at a later point in time. For example, given inquiries by the addressee with a contact person of the sender or with organizations (for example call centers) commissioned by the sender, it can be checked whether the print images of the generated documents have been correctly generated or which information is actually visible to a reader in the printed document. Given inquiries by the recipient, contact persons in an organization or in a call center can thus not only provide information that a document has been sent but moreover can make a statement of whether the content of the send document was legible. For example, important information can be illegible, in particular given paper errors. Important information can also be illegible due to overlapping of the print image with print images already printed on the medium material. However, it is desirable and achievable that a conclusion about the legible content of the document can be made even after sending the document, in particular given the sending of documents with a legally relevant content. Such documents are, for example, contracts, policies, terms of business, invitations to general shareholders' meetings of listed corporations, and other writs and documents in which it is desirable that it can be checked which information was actually contained in a sent document.

According to an advantageous exemplary embodiment of the invention, given documents that comprise multiple printed pages of a standard paper form, the image data of these printed pages are archived with the same index information, in particular in a data set and/or a file. These image data can in particular be generated via the recording of the printed front side of a single sheet and the printed back side of a single sheet or of a single sheet cut from a paper web after printing. The recording of the printed print images advantageously occurs with the aid of a camera (advantageously a digital camera with a CCD element), wherein a stroboscopic light source is advantageously used to illuminate the printed print image.

Additionally or alternatively, the recording unit can also read one-dimensional and/or two-dimensional barcodes and/or to detect magnetizable printing materials (such as magnetic toners (MICR toner), magnetic inks (MICR inks) or printing material reflecting infrared light provided in order to record the print image information.

Magnetic toners and magnetic inks respectively contain magnetizable particles via which the surfaces inked with this toner or this ink can be recorded with the aid of suitable recording units; graphical characters can in particular be read. Multiple similar recording units, in particular multiple cameras or multiple devices to read print images printed with magnetizable printing materials and/or for detection of barcodes, can be provided whose acquisition ranges overlap one another or border one another so that a correspondingly larger total acquisition range is formed. All relevant regions of the printed medium material can thereby be recorded, in particular at the printing speeds typical in high-capacity printing systems or high-capacity copying systems, without having to reduce the possible printing speed of the high-capacity printing system or high-capacity copying system due to the recording process.

The printing or copying system is advantageously an electrographic (in particular electrophotographic) printing or copying system in which documents with print objects generated from variable data (for example letters to different recipients) can also be produced quickly and cost-effectively.

It is advantageous to use multi-color print images with the aid of detection units to record color images, in particular analog or digital color image cameras. However, multi-color print images can also be recorded and archived as greyscale images or black-and-white images to achieve a higher scan speed and/or to reduce the data quantity to be archived.

In addition to the cited archiving data, production data of the printing process can also be recorded and archived. Such production data are, for example: image processing parameters of the controller/raster image process; electrographic (in particular electrophotographic) settings of the printing or copying system (for example the value of a bias voltage that serves as a transfer assistance voltage to transfer toner particles to surfaces or surface regions of image media and/or intermediate image carriers, moisture); parameters of the media material such as substance, paper quality etc.; properties of the employed toner material; properties and/or status of the carrier particles etc. Such data can then be used in a later reprinting of the document or a portion of the document using the archived document data in order to enable a reprint of the originally generated document that is optimally true to the original. If necessary the archived production data of the printing process can be used in order to produce values of parameters of the printing or copying system that are to be preset with whose aid the document or the portion of the document should be reprinted. A reprint that is optimally true to the original is thereby achieved.

For a better understanding of present invention, in the following reference is made to the preferred exemplary embodiments presented in the drawings, which are described using specific terminology. However, it is noted that the protective scope of the invention should not thereby be limited, since such variations and additional modifications to the shown devices and/or the described methods, as well as such additional applications of the invention as they are indicated therein, are viewed as typical present or future expertise of a competent man skilled in the art. The drawing figures show exemplary embodiments of the invention.

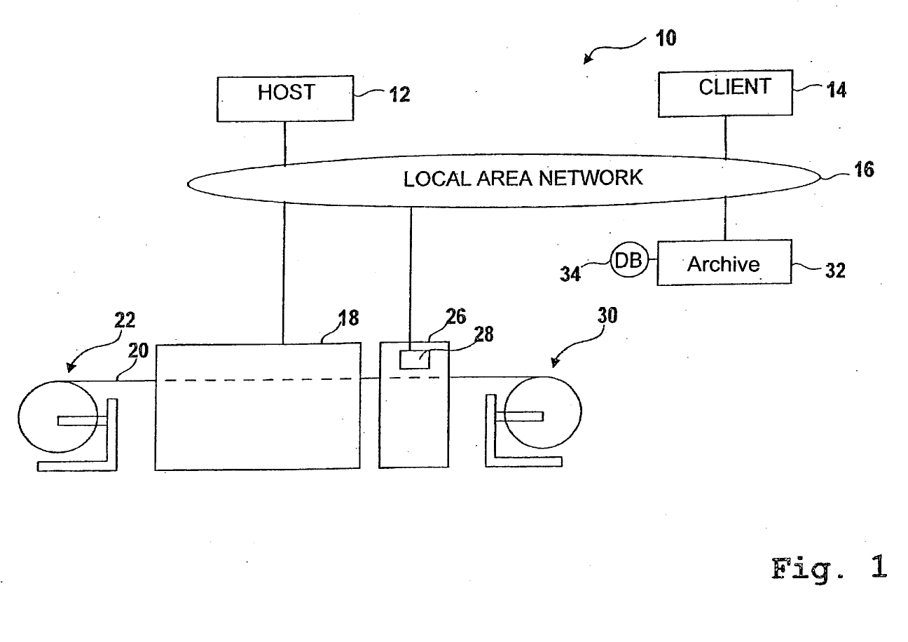

A system for recording and archiving of print images printed on a medium material 20 according to a first embodiment of the invention is schematically presented in FIG. 1. A host computer 12, a client computer 14, an archive system 32, a printer 28 and a recording unit 26 downstream from the printer 18 are connected via a local network (LAN) 16. The recording unit 26 contains a digital camera 28 to record the print images printed on the medium material 20 with the aid of the printer 18. A paper web 20 rolled off by a roller 22 is supplied to the printer 18 as a medium material for printing, wherein the printer prints this paper web 20 on the front side with at least one print image corresponding to the print data supplied by the host computer 12 or client computer 14.

After the generation of at least one print image on the front side of the paper web 20 with the aid of the printer 18, this print image is recorded with the aid of the digital camera 29 of the recording unit 26, wherein the paper web 20 is wound onto a roller 30 after printing. The rolling-off of the paper web 20 occurs with the aid of the aid of what is known as an unroller, and the rolling up of the paper web 20 occurs with the aid of what is known as a winder.

A print server and/or a document management system as well as an output management system can also be provided to administer the print jobs generated by the host computer 12 and the client computer 14. Print data streams can be processed and optimized for the output with the aid of the printer 18 with such a print server, an output management system or a document management system. Indexing information can be used, for example from the print data that are contained in the print data stream supplied to the printer 18 and/or in a job ticket of the print job. Such an indexing possibility as well as additional indexing and archiving possibilities of print data are described in detail in the German patent application DE 10 2006 006 060 (not previously published), the content of which is herewith incorporated by reference into the present specification.

The archive system 32 is connected with a database 34 in which data to be archived are stored, advantageously in data sets.

With the aid of the digital camera 29 of the recording unit 26, the print image or the print images of at least one selected print job (or alternatively all print jobs executed with the aid of the printer 18 for generation of print images) are recorded and converted into image data. The image data are transferred via the local network 26 to the archive system 32 and are stored by the archive system 32 in the database 34. These image data are advantageously provided with indexing information such as the print date, the shipping date, a print job number or an address information of a recipient to which a document generated from the printed paper web 20 is sent. The archived image data of the print printed images recorded with the aid of the camera 28 are thus indexed, i.e. are provided with indexing information so that they can be located simply at a later point in time in the database 34 by the archive system 32 with the aid of this indexing information or an item of this indexing information. Via this simple location of the image data, the client computer 14, the host computer 12 or an additional computer connected with the network 16 or via an additional network (not shown), or a data processing system connected with the network, can read out the archived image data in a targeted manner from the database 34. Even after sending a document, it can therefore be determined with certainty how the print image of a printed document actually appeared after it left the printer 18.

In particular given telephone inquiries by the recipient of a printed document, a search process for the image data of this document can be executed with the aid of the archive system 32 given reference to a document sent to the recipient. The image data of the corresponding document that are determined in this search can be read from the database 34 and, for example, transferred to the client computer 14 that is operated by an employee who receives the inquiry by the recipient. Even given inquiries by recipients that are handled by a call center, via the preferred embodiment it is also possible to allow the call center access to the archive system 32 and thus to the data stored in the database, whereby images of the documents sent to a recipient can then be displayed to an employee of the call center, whereby the call center employee or the authorized user can simply check which information actually went to the recipient.

Via the archiving of the recorded image data of the printed print images, the quality of the printed elements can also be checked at a later point in time if, for example, complaints occur that pertain to the already delivered and/or shipped print products or documents. A conclusion about the quality and/or the information content of printed documents can thus be made in a simple manner with the aid of the system 10.

As an alternative or in addition to the digital camera 28, the recording unit 26 can also comprise laser scanners (in particular barcode scanners) or readers to read printing inks contained with magnetizable particles, which scanners or readers record a print image printed with these printing inks and convert them into image data. From the document U.S. Pat. No. 6,137,967 it is also known to record printed elements with the aid of a recording unit and to check whether the recorded elements coincide with the respective elements specified by the print data. In particular, read, input, and processing errors in the generation of printed documents should therefore be determined. Such arrangements are also known from the documents U.S. Pat. No. 5,978,477, U.S. Pat. No. 5,940,584 and U.S. Pat. No. 6,324,353. The content of these documents is herewith incorporated by reference into the present specification.

The print images are advantageously illuminated with the aid of a suitable light source for recording. Such a light source is in particular a stroboscopic and/or flash exposure device. Given high print speeds, multiple recording units 26 or multiple digital cameras 28 are also arranged in series so that their acquisition ranges in the transport direction of the paper web 20 have an increased total acquisition range relative to the acquisition range of a single camera 28. The edges of adjacent acquisition ranges advantageously border one another or overlap slightly.

In addition, the recording unit 26 as well as the digital camera 28 can be used to monitor the printed print image, as this is described in the document U.S. Pat. No. 6,137,967. What was actually coped onto a printed medium material 20 that has left the printer 18 can thus be tracked with certainty with the aid of the system 10. The images of the printed print images can simply be searched for and displayed, or output at a later point in time via an encoding of the recorded data, in particular via an indexing and archiving, whereby the content of these documents can also be exactly determined at a later point in time. The recording unit can also contain an MICR reader in order to record print images printed with the aid of MICR toner or MICR ink. This is also possible through the envelope after the enveloping of a printed document in the envelope. The output of this recorded image information at a later point in time is then also possible in a simple manner.

Via the preferred embodiment, at least portions of the printed print images are recorded after transfer printing of these print images onto a medium material 20 and are converted into image data that are then stored (i.e. archived). They are advantageously combined with information that are contained in the print data stream or the print job supplied to a controller of the printer 18. Print data and image data are thus stored together with print images generated with the aid of these print data, i.e. are archived in common. An indexing of the recorded image data is also possible via this common archiving. Via such an indexing, and via an indexing with the aid of additional index information, the later location or the later retrieval of these image data for output with the aid of a display unit of the printer 18 or another printer is possible in a simple manner. The archived image data can also simply be transferred via the data network 16 or another data network, in particular a global network such as the WWW (Internet). Such a transfer is in particular possible with the aid of an e-mail. The controller of the printer 18 is in particular in the position to interpret (what is known as parsing) the print data stream of a classical print data language such as, for example: PostScript, Printer Control Language (PCL), Advanced Function Presentation (AFP) or the extended version MO:DCA, Intelligent Printer Data Stream (IPDS), Portable Document Format (PDF) or the like. Furthermore, it in particular generates rastered data from the print data stream. It can additionally interpret job ticket data as necessary and comprise corresponding control commands to the printing apparatus or to additional apparatuses (such as, for example, winders, cutters, binders—what are known as finishing apparatuses) for processing of the printed documents. Index data can thus be formed or extracted from the data that the controller processes or generates, and these data can be combined with data that are formed by the camera upon scanning the corresponding printing documents, including index data formed via optical character recognition (OCR), or these can be referenced to one another.

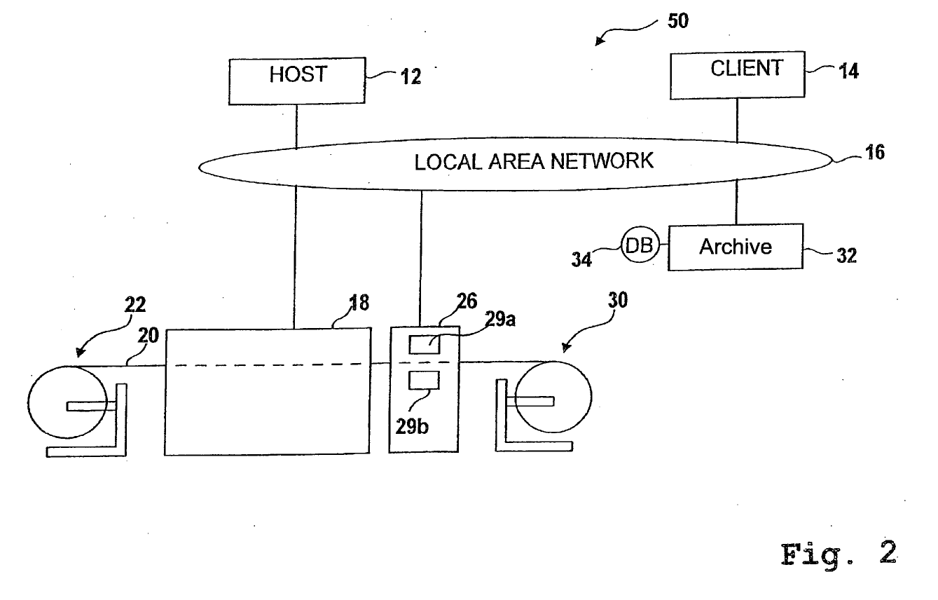

A system 50 to record and archive print images printed on a medium material 20 according to a second embodiment of the invention is schematically shown in FIG. 2. The system 50 has a design similar to the system 10 shown in FIG. 1. Elements with the same design or the same function have the same reference characters.

In the system 50 according to FIG. 2, the paper web 20 can be printed both on the front side and on the back side with the aid of the printer 18, whereby a medium material 20 printed double-sided is supplied to the recording unit 26 for recording. The recording unit 26 contains a first digital camera 29a and a second digital camera 29b, wherein the digital camera 29a records the print images printed on the front side of the medium material 20 and the digital camera 29b records the print images printed on the back side of the medium material 20. The recorded print images are converted into image data with the aid of the recording unit 26 or with the aid of the digital cameras 29a, 29b, which image data are supplied to the archive system 32 for archiving, as this has already been described in connection with FIG. 1 for the image data acquired with the aid of the camera 28. The print images recorded on the front side and the print images simultaneously recorded on the back side of an areal section of the medium material 20 with the aid of the cameras 29a, 29b are advantageously associated with one another in the database 34, and advantageously are stored in a data set or a document.

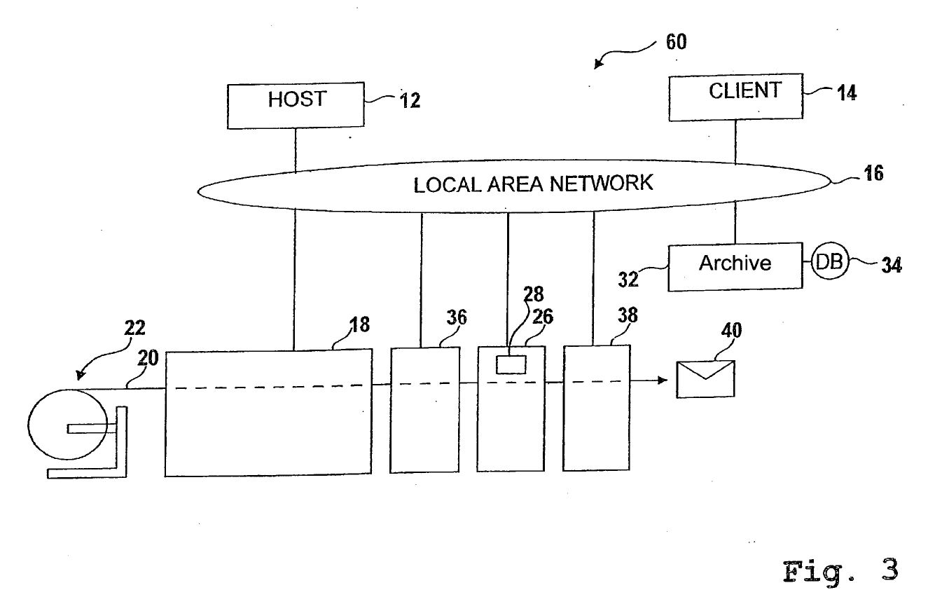

A system 60 to record print images printed on a medium material according to a third embodiment of the invention similar to the system 10 according to FIG. 1 is shown in FIG. 3. In contrast to the system 10 according to FIG. 1, the system 60 according to FIG. 3 has a post-processing unit 36 to cut the paper web 20 into single sheets, wherein the generated print images or the print image generated with the aid of the printer 18 is recorded with the aid of the digital camera 28 of the recording unit 26 and archived, as described in connection with FIGS. 1 and 2. A second post-processing unit 38 for folding and enveloping the cut single sheets is also provided, wherein the printed documents recorded with the aid of the recording unit 26 are sent to a recipient as a letter 40. Address information of the recipient to whom the letter 40 is addressed is advantageously used to index the recorded image data. As described in connection with FIG. 2, the printer 18 can also provide the paper web 20 with a print image on the front side and on the back side. As described in connection with FIG. 2, it is then advantageous to respectively provide two recording devices 29a, 29b (in particular two digital cameras), wherein one of these cameras respectively records the front side and the other camera records the back side of the single sheets. Alternatively, a single sheet 43 can be turned over after recording the front side and be supplied again to the recording unit 26, whereby only one recording device (in particular only one digital camera) must be provided. This is possible in at least one of more embodiments of the invention.

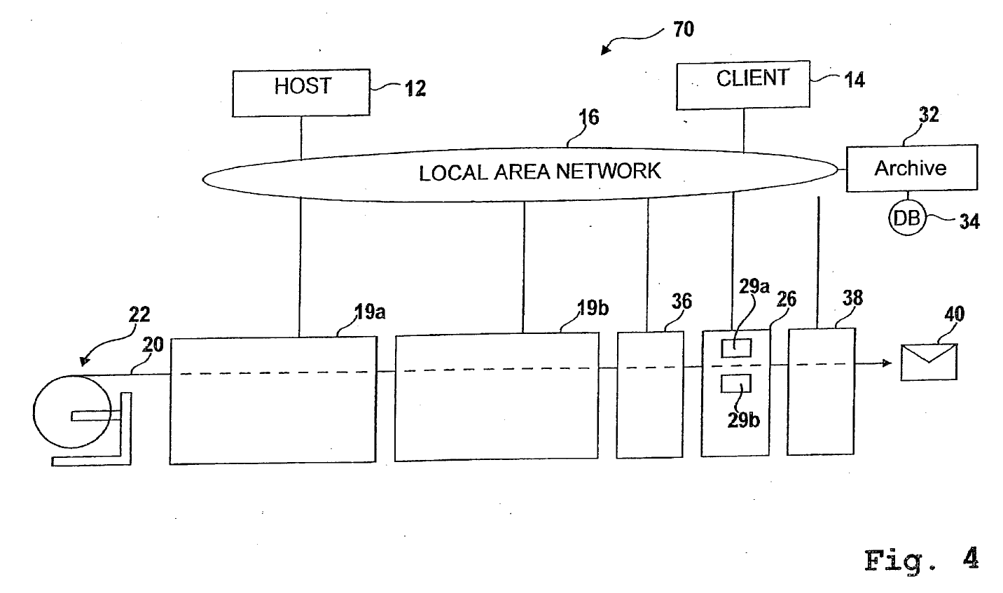

A system 70 for recording and archiving of print images printed on a medium material 20 according to a fourth embodiment of the invention is shown in FIG. 4. In the system 70, a first printer 19a for printing the front side of the paper web 20 and a second printer 19b for printing the back side of the paper web 20 are provided. A turner (not shown) to turn over the paper web 20 is provided between the printers 19a, 19b, whereby the printers 19a, 19b can have the same design. The printers 19a, 19b are operated as what are known as a tandem printing system, wherein the printers 19a, 19b are coupled with one another in a suitable manner. In particular, portions of the control processes of the printer 19b are controlled by the printer 19a. As described in connection with FIG. 3, the post-processing unit serves to separate or cut the paper web 20 into single sheets, wherein the front side of these single sheets is recorded with the aid of the digital camera 29b and the back side of these single sheets is recorded with the aid of the camera 19a of the recording unit 26. The single sheets are subsequently enveloped with the aid of the post-processing unit 38 and provided for shipping as letter mailing 40.

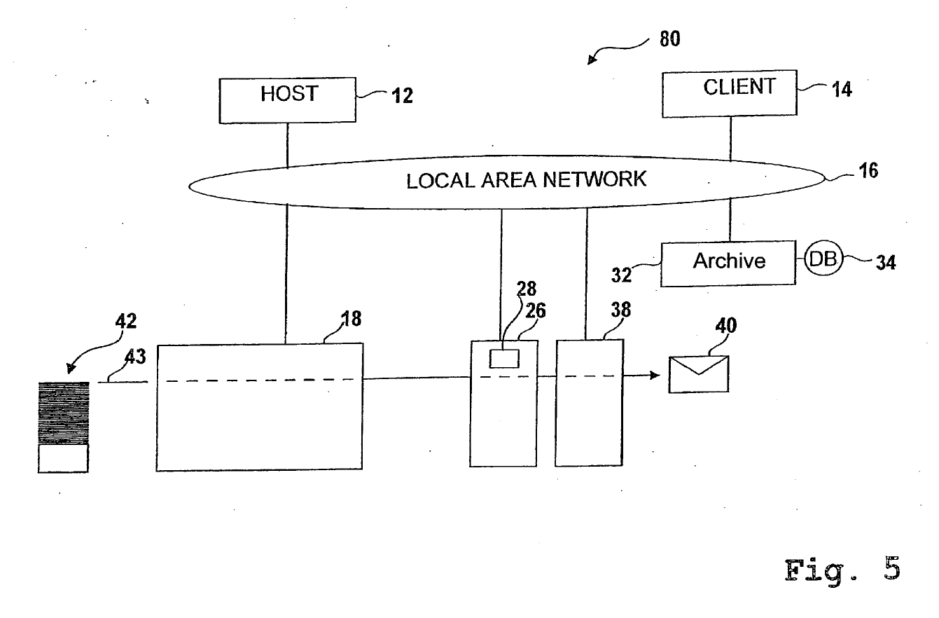

A system 80 for recording and archiving of a print image printed on a single sheet 43 according to a fifth embodiment of the invention is shown in FIG. 5. Single sheets are supplied to the printer in succession from a sheet stack 42. Upon the infeed of the single sheets 43, immediately following single sheets 43 are transported with a suitable separation from one another. Image exposures of the print images generated on the single sheets 43 and of the singe sheet 43 are acquired with the aid of the camera 28 of the recording unit 26. The single sheets 43 are folded and enveloped with the aid of the post-processing unit 38 and output as a shipping-ready letter mailing 40.

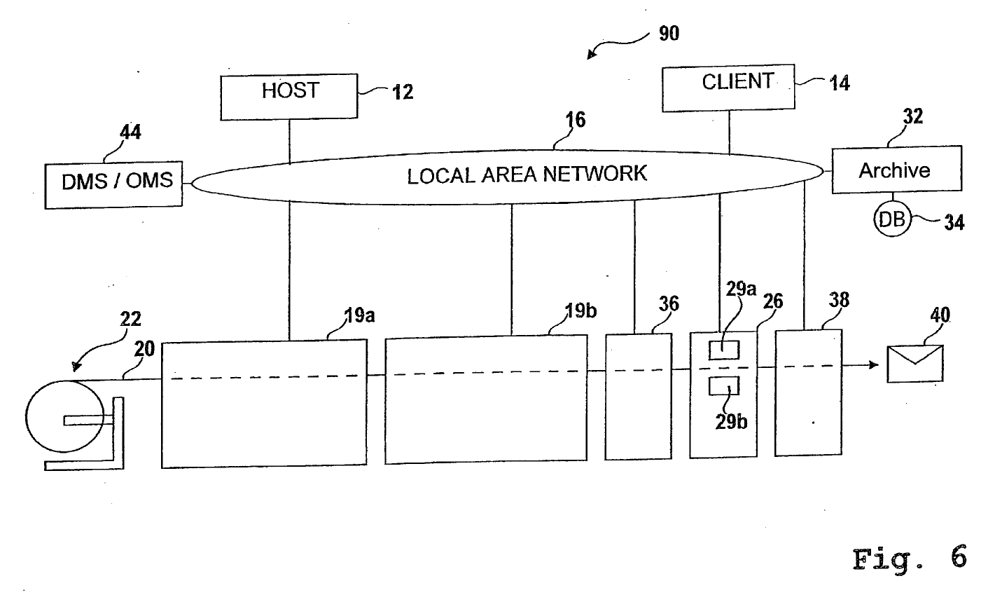

A system 90 to record and archive print images printed on a medium material 20 according to a sixth embodiment of the invention is shown in FIG. 6. In the system 90, a document management and output management system 44 is connected with the local network 16, which document management and output management system 44 receives the print jobs supplied by the host computer 12 or client computer 14 and supplies corresponding print data streams to the printers 19a, 19b. The document management system 44 can also be used to supply the image data recorded with the aid of the recording unit 26 to the archive system 32 for archiving. The document management system 44 can thereby also add indexing information to the image data to be archived. Additionally or alternatively, the archive system 32 add the indexing information to the archived image data, as already described in connection with FIGS. 1 through 5.

Additionally or alternatively, the printers 19a, 19b can respectively be print the front side and the back side of the paper web 20 with a respective print image. The printer 19a advantageously prints the front side and the back side of the paper web 20 with a respective print image of a first print color, and the printer 19b respectively prints the front side and the back side of the paper web 20 with a print image of a second print color differing from the print color of the first printer 19a. Two color separations can thereby be printed atop one another on a surface of the paper web 20 with the aid of the printers 19a, 19b, such that a two-color print image can be generated both on the front side and on the back side with the aid of such a tandem printing system. Alternatively, the printer 19a can print the front side of the paper web 20 with a print image of a first print color and the printer 19b can print with a print image of a second color different from the first color, whereby the paper web 20 is printed with a two-color print image on one side.

The cameras 28, 29a, 29b of the various embodiments can record the print images as color images, as greyscale images, or as black-and-white images. In particular, the cameras 28, 29a, 29b can also record multicolor print images as greyscale images or black-and-white images, whereby the storage requirement necessary for archiving can be reduced, and whereby the recording with the aid of the cameras 28, 29a, 29b (in particular with the aid of CCD elements) can occur faster. This is in particular advantageous in high-capacity printing systems and high-capacity copying systems.

The document management system and/or output management system 44 explained in connection with FIG. 6 can be used in the same manner as in the other embodiments that have been explained in connection with FIGS. 1 through 5. The recording of the printed print images according to the preferred embodiment can in particular be applied independent of the employed printing principle, of the number of the employed print colors and of the printed medium material. However, with the aid of the recording unit 26 it is advantageous to record and to archive images of printed medium material that have been printed with the aid of an electrographic (in particular an electrophotographic) printing or copying system.

Additional pre- and/or post-processing devices can be provided, in particular for folding, binding, surface finishing and other known pre- and post-processing processes. Print images, in particular a logo or a letterhead, can already be provided on the medium material to be printed (in particular on the paper web 20 or the single sheet 43) before the printing with the aid of the printers 18, 19a, 19b. Multiple paper supplies (in particular multiple sheet stacks 42) can be provided from which single sheets 43 corresponding to the print job or suitable for the print job can be drawn.

In addition to the cited archiving data, production data of the printing process can also be recorded and archived. Such production data are, for example: image processing parameters of the controller/raster image processor; graphic (in particular electrographic, in particular electrophotographic) settings of the printing or copying system such as, for example, the value of bias voltage that serves as a transfer assistance voltage to transfer toner particles to surfaces or surface regions of image media and/or intermediate image carriers, moisture); parameters of the media material such as substance, paper quality etc.; properties of the employed toner material; properties and/or status of the carrier particles etc. Such data can then be used in a later reprinting of the document or a portion of the document using the archived document data in order to enable a reprint of the originally generated document that is optimally true to the original. If necessary the archived production data of the printing process can be used in order to produce values of parameters of the printing or copying system that are to be preset with whose aid the document or the portion of the document should be reprinted. A reprint that is optimally true to the original is thereby achieved.

Although preferred exemplary embodiments have been displayed and described in detail in the drawings and in the preceding specification, these should be viewed as purely exemplary and not as limiting the invention. It is noted that the preferred exemplary embodiments are shown and described, and all variations and modifications that presently and in the future lie within the protective scope of the invention should be protected.

I claim as my invention:

1-26. (canceled)

27. A method to archive print images, comprising the steps of:
recording at least one print image generated with aid of a printing or copying system with aid of a recording unit;
generating image data corresponding to the recorded print image;
archiving the image data in an archive; and
storing at least one part of print data used to generate the print image together with the image data in the archive.

28. A method according to claim 27 wherein: information about production parameters for production of the print image; for pre- or post-processing of a printed or to-be-printed medium material; image processing parameters of a raster image processor; preset electrographic parameters of the printing or copying system; or additional parameters for generation or processing of the printed or to-be-printed material are stored together with the recorded image data in the archive.

29. A method according to claim 27 wherein the print image recorded with aid of the recording unit comprises at least one region of a print page, one print page, or regions of multiple print pages, and wherein the print page has dimensions of a standard paper format.

30. A method according to claim 27 wherein:
a medium material on which the print image is generated with aid of the printing or copying system is processed further with aid of at least one post-processing unit; and
the recording unit records the print image after additional processing of the medium material with aid of the at least one post-processing unit wherein the medium material comprises a web-shaped medium material.

31. A method according to claim 27 wherein the method is embedded into a production workflow for generation of print products, wherein a production line for implementation of a production workflow is provided that comprises an unwinder, a pre-processing unit, and a post-processing unit in addition to the printing or copying system to generate the print image on a medium material.

32. A method according to claim 27 wherein the recording unit comprises an optical recording unit.

33. A method according to claim 27 wherein the recording unit comprises an illumination arrangement to illuminate the print image to be recorded.

34. A method according to claim 27 wherein at least two recording units are provided whose acquisition regions are arranged one after another in a transport direction of a medium material, such that portions of the print image arranged in the acquisition regions of the recording units, or the print images arranged in the acquisition ranges of the recording units, are simultaneously recorded.

35. A method according to claim 27 wherein a print image comprising at least two primary colors is generated with aid of the printing or copying system.

36. A method according to claim 27 wherein at least a portion of a medium material is printed on both sides, wherein the print images generated on a front side and on a back side of the medium material are recorded with aid of the recording unit.

37. A method according to claim 27 wherein the image data archived in the archive are read out and output from the archive with aid of at least one item of indexing information.

38. A method according to claim 27 wherein the image data pertain to at least one sent document.

39. A device for archiving of print images, comprising:
a recording unit to record a print image and to generate image data corresponding to the recorded print image;
an archive for storing at least one part of print data used for the generation of the print image, together with the image data; and
a storage unit to store the print data together with the image data in the archive.

40. A device according to claim 39 wherein the print image is generated with aid of a printing system or copying system integrated into a production line for generation of print products.
